(19) United States
(12) Patent Application Publication
(10) Pub. No.: US 2024/0097823 A1
(43) Pub. Date: Mar. 21, 2024

(54) REPETITION VALUE FOR UPLINK COMMUNICATION

(71) Applicant: QUALCOMM Incorporated, San Diego, CA (US)

(72) Inventors: Mohamad SAYED HASSAN, Paris (FR); Lianghai JI, San Diego, CA (US); Xiao Feng WANG, San Diego, CA (US); Liangping MA, San Diego, CA (US); Jun MA, San Diego, CA (US)

(21) Appl. No.: 17/934,065

(22) Filed: Sep. 21, 2022

(51) Int. Cl. H04L 1/08; H04W 72/04

(52) U.S. Cl. CPC H04L 1/08; H04W 72/048

(57) ABSTRACT

Various aspects of the present disclosure generally relate to wireless communication. In some aspects, a user equipment (UE) may receive configuration information indicating a plurality of repetition values for an uplink communication of the UE. The UE may transmit the uplink communication using a number of repetitions indicated by a repetition value of the plurality of repetition values, wherein the repetition value is based at least in part on a power class of the UE. Numerous other aspects are described.

### BACKGROUND

### Field of the Disclosure

Aspects of the present disclosure relate to wireless communications, and more particularly, to techniques for a repetition value for uplink communication.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving configuration information indicating a plurality of repetition values for an uplink communication of the UE. The method includes transmitting the uplink communication using a number of repetitions indicated by a repetition value of the plurality of repetition values, wherein the repetition value is based at least in part on a power class of the UE.

Another aspect provides a method for wireless communication by a network entity. The method includes outputting configuration information indicating a plurality of repetition values for an uplink communication of a UE. The method further includes obtaining the uplink communication using a number of repetitions indicated by a repetition value of the plurality of repetition values, wherein the repetition value is based at least in part on a power class of the UE.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is a diagram illustrating an example of a regenerative satellite deployment and an example of a transparent satellite deployment in a non-terrestrial network.

FIG. 6 is a diagram illustrating an example of signaling associated with selecting a number of repetitions for an uplink transmission.

FIG. 7 depicts a method for wireless communications.

FIG. 8 depicts a method for wireless communications.

FIG. 9 depicts aspects of an example communications device.

FIG. 10 depicts aspects of an example communications device.

### DETAILED DESCRIPTION

Aspects of the present disclosure provide apparatuses, methods, processing systems, and computer-readable mediums for selection of a repetition value for uplink transmissions, such as for non-terrestrial network communications.

A radio access network (RAN) may facilitate communication between user equipments (UEs) and network nodes, such as base stations, central units, distributed units, radio units, and so on. Communication from a node of the RAN to a UE is referred to as downlink communication, and communication from the UE to the node of the RAN is referred to as uplink communication. Generally, uplink communications are more limited in coverage than downlink communications because UEs tend to have a lower transmit power than network nodes (due to UEs being limited to using battery power to transmit and having less powerful radio frequency (RF) hardware, among other reasons). “Coverage enhancement” refers to techniques used to extend the coverage of a transmission, such as an uplink communication or a downlink communication. In some examples, a UE or a network node may perform repetition of a communication to achieve coverage enhancement. Repetition involves transmission of a communication multiple times (such as with different redundancy versions, in some examples). As one example, a transmitter may transmit a physical channel (e.g., a physical uplink shared channel (PUSCH) or another type of channel) multiple times in a configuration enabling joint channel estimation of the physical channel, which may be referred to as demodulation reference signal (DMRS) bundling. As another example, a transmitter may transmit multiple repetitions of a communication according to a number of repetitions indicated by a grant associated with the communication. As yet another example, a transmitter may transmit a transport block over a multi-slot physical uplink shared channel.

A non-terrestrial network (NTN) is an example of a RAN. In an NTN, a UE communicates with a non-terrestrial network node, such as a gNB at a satellite or a satellite serving as a relay for a terrestrial gateway. NTNs have high round-trip delay (RTD) in comparison to a terrestrial network (TN) due to the UE having a larger separation from the network node in the NTN than in the TN. Furthermore, NTNs may benefit from coverage enhancement, such that communications in an NTN are more reliable. As mentioned above, one example of coverage enhancement is repetition of a communication. However, traditional techniques for indication of a number of repetitions for a communication may be impractical in an NTN, and an appropriate number of repetitions may vary in different situations. For example, radio resource control (RRC) configuration of a number of repetitions may involve considerable delay and overhead. As another example, dynamic signaling (e.g., downlink control information, physical layer signaling) of a number of repetitions mitigates the benefits of repetition with regard to hybrid automatic repeat request (HARQ) retransmissions and may be impractical due to the high RTD of an NTN. Thus, network signaling (e.g., signaling from a network node) indicating a number of repetitions (e.g., a repetition value) may be impractical, may introduce delay, and may increase overhead.

Some techniques described herein provide selection, at a UE, of a repetition value from a plurality of repetition values. The UE may select the repetition value based at least in part on, for example, a reference signal received power (RSRP), an elevation angle between the UE and a network node (e.g., a satellite comprising or associated with the network node), a power class of the UE, or a combination thereof. Selection of the repetition value based at least in part on an elevation angle may provide improved accuracy of selection of the repetition value and thus improved efficiency of uplink communication in NTNs, since path loss is correlated with elevation angle in NTNs. Selection of the repetition value based at least in part on the power class, the elevation angle, and/or the RSRP enables the UE to select an appropriate number of repetitions without receiving explicit signaling identifying the number of repetitions, which improves practicality of selection of repetition values (particularly in NTNs), reduces delay, and reduces overhead. Furthermore, the UE can derive a flexible number of repetitions (which can change based on changing parameters at the UE) without dynamic signaling.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

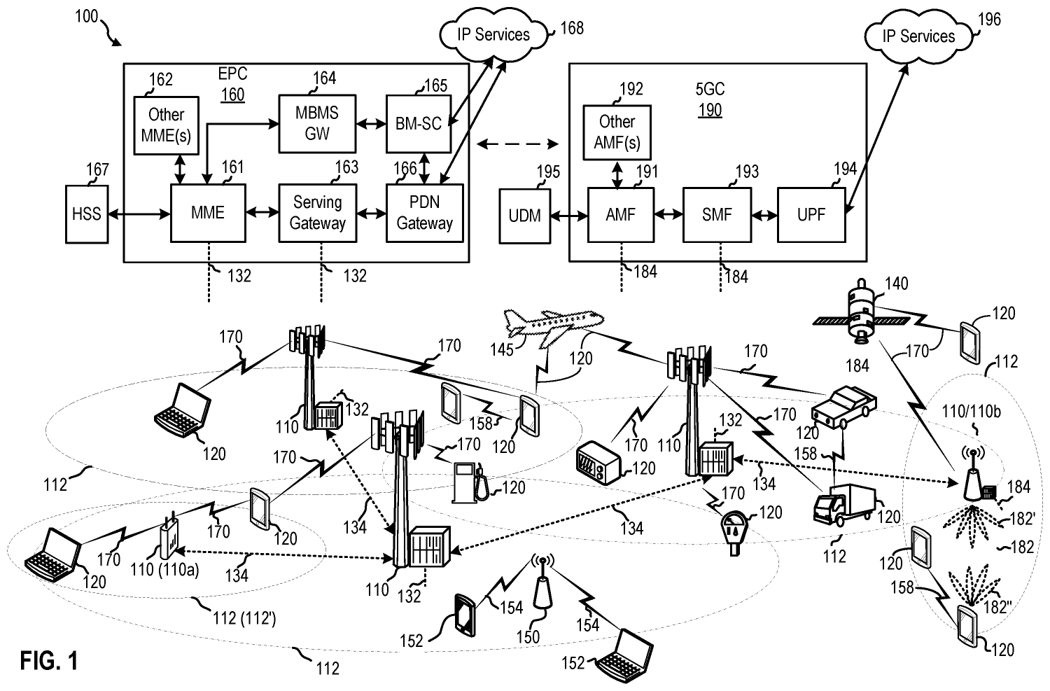

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) device, always on (AON) device, edge processing device, or another similar device. A UE 120 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

BSs 110 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

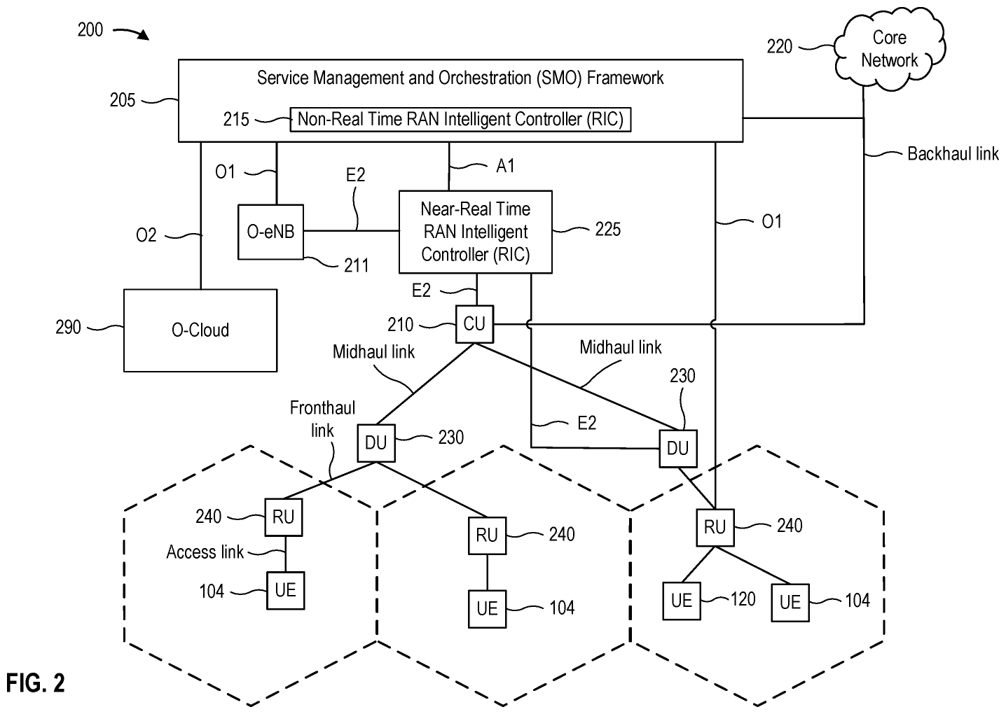

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 110) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 110 within wireless communications network 100 may also be configured to support different radio access technologies, such as 3G, 4G, and/or 5G. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is the control node that processes the signaling between the UEs 120 and the EPC 160. Generally, MME 161 provides bearer and connection management.

Generally, user Internet protocol (IP) packets are transferred through Serving Gateway 163, which itself is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may be used to distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, or a transmission reception point (TRP), to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 120 via one or more radio frequency (RF) access links. In some implementations, the UE 120 may be simultaneously served by multiple RUs 240.

Each of the units (e.g., the CUs 210, the DUs 230, the RUs 240, as well as the Near-RT RICs 225, the Non-RT RICs 215 and the SMO Framework 205) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over-the-air (OTA) communications with one or more UEs 120. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240, and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence/machine learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

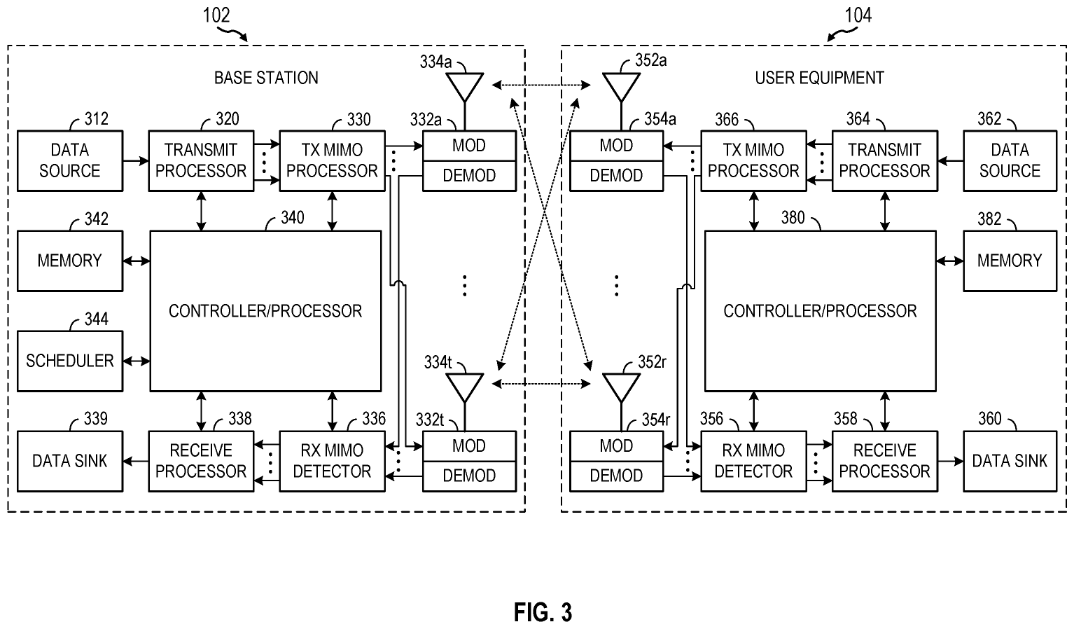

FIG. 3 depicts aspects of an example BS 110 and UE 120.

Generally, BS 110 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 110 may send and receive data between BS 110 and UE 120. BS 110 includes controller/processor 340, which may be configured to implement various functions described herein related to wireless communications.

Generally, UE 120 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 120 includes controller/processor 380, which may be configured to implement various functions described herein related to wireless communications.

In regard to an example downlink transmission, BS 110 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 120 includes antennas 352a-352r that may receive the downlink signals from the BS 110 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 120 to a data sink 360, and provide decoded control information to a controller/processor 380.

In regard to an example uplink transmission, UE 120 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 110.

At BS 110, the uplink signals from UE 120 may be received by antennas 334a-t, processed by the demodulators in transceivers 332a-332t, detected by a MIMO detector 336 if applicable, and further processed by a receive processor 338 to obtain decoded data and control information sent by UE 120. Receive processor 338 may provide the decoded data to a data sink 339 and the decoded control information to the controller/processor 340. Memories 342 and 382 may store data and program codes for BS 110 and UE 120, respectively. Scheduler 344 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

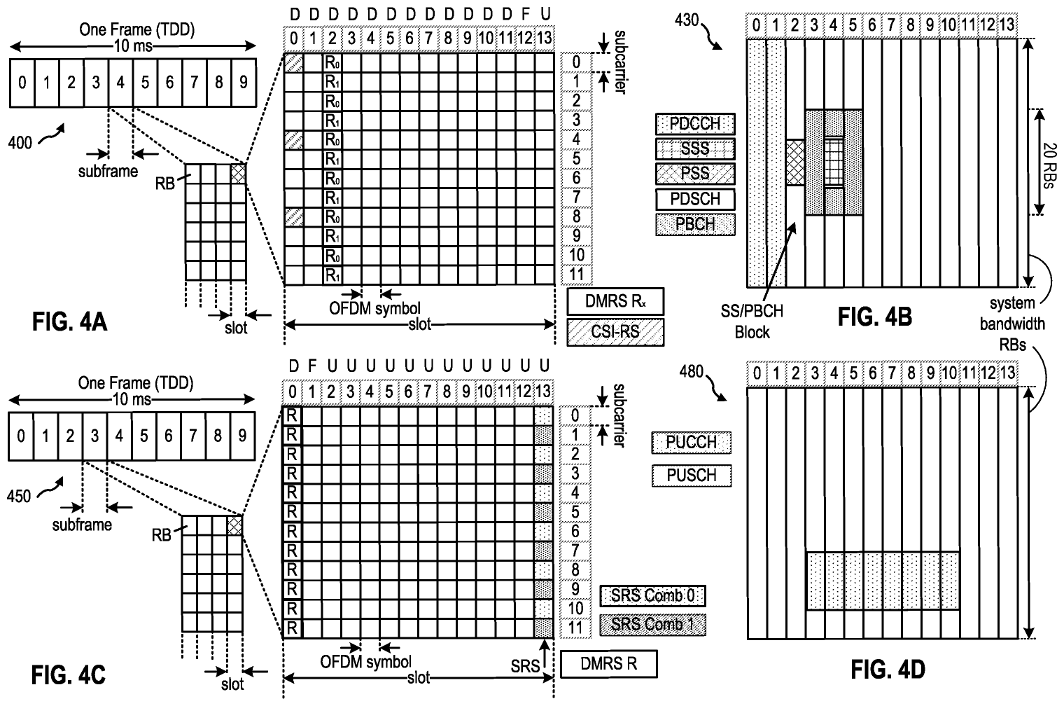

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2 slots/subframe. The subcarrier spacing and symbol length/duration are a function of the numerology. The subcarrier spacing may be equal to 21×15 kHz, where is the numerology 0 to 5. Accordingly, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120 of FIGS. 1 and 3). The RSs may include demodulation RSs (DMRSs) and/or channel state information reference signals (CSI-RSs) for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Repetition for Uplink Transmission

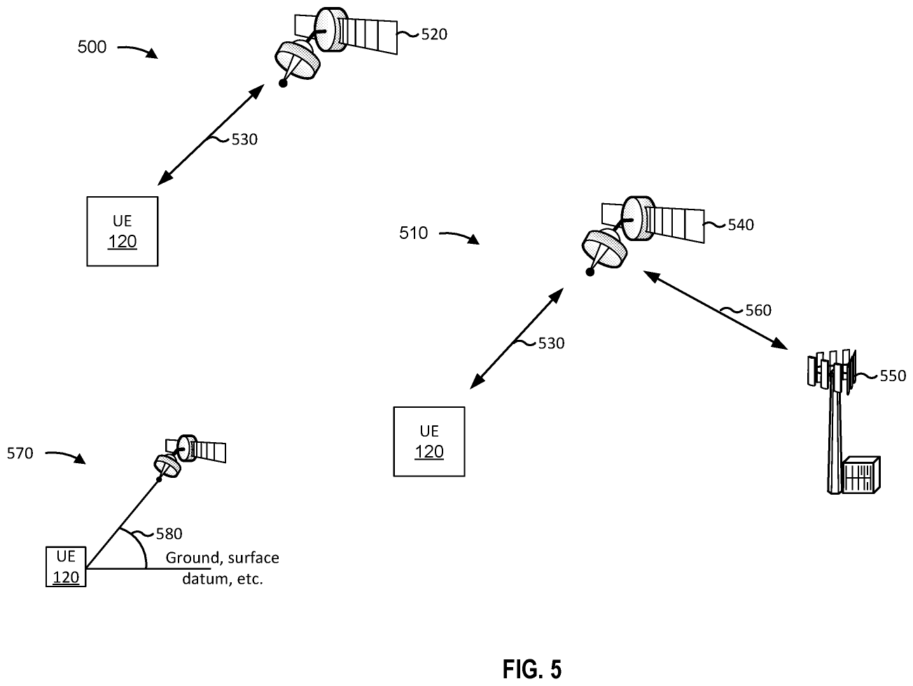

FIG. 5 is a diagram illustrating an example 500 of a regenerative satellite deployment and an example 510 of a transparent satellite deployment in a non-terrestrial network.

Example 500 shows a regenerative satellite deployment. In example 500, a UE 120 is served by a satellite 520 via a service link 530. For example, the satellite 520 may include a base station 110 (e.g., a gNB). In some aspects, the satellite 520 may be referred to as a non-terrestrial base station, a regenerative repeater, or an on-board processing repeater. In some aspects, the satellite 520 may demodulate an uplink radio frequency signal, and may modulate a baseband signal derived from the uplink radio signal to produce a downlink radio frequency transmission. The satellite 520 may transmit the downlink radio frequency signal on the service link 530. The satellite 520 may provide a cell that covers the UE 120.

Example 510 shows a transparent satellite deployment, which may also be referred to as a bent-pipe satellite deployment. In example 510, a UE 120 is served by a satellite 540 via the service link 530. The satellite 540 may be a transparent satellite. The satellite 540 may relay a signal received from gateway 550 via a feeder link 560. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 530 to a frequency of the uplink radio frequency transmission on the feeder link 560, and may amplify and/or filter the uplink radio frequency transmission. In some aspects, the UEs 120 shown in example 500 and example 510 may be associated with a Global Navigation Satellite System (GNSS) capability or a Global Positioning System (GPS) capability, though not all UEs have such capabilities. The satellite 540 may provide a cell that covers the UE 120.

The service link 530 may include a link between the satellite 540 and the UE 120, and may include one or more of an uplink or a downlink. The feeder link 560 may include a link between the satellite 540 and the gateway 550, and may include one or more of an uplink (e.g., from the UE 120 to the gateway 550) or a downlink (e.g., from the gateway 550 to the UE 120). An uplink of the service link 530 may be indicated by reference number 530-U (not shown in FIG. 5) and a downlink of the service link 530 may be indicated by reference number 530-D (not shown in FIG. 5). Similarly, an uplink of the feeder link 560 may be indicated by reference number 560-U (not shown in FIG. 5) and a downlink of the feeder link 560 may be indicated by reference number 560-D (not shown in FIG. 5).

The feeder link 560 and the service link 530 may each experience Doppler effects due to the movement of the satellites 520 and 540, and potentially movement of a UE 120. These Doppler effects may be significantly larger than in a terrestrial network. The Doppler effect on the feeder link 560 may be compensated for to some degree, but may still be associated with some amount of uncompensated frequency error. Furthermore, the gateway 550 may be associated with a residual frequency error, and/or the satellite 520/540 may be associated with an on-board frequency error. These sources of frequency error may cause a received downlink frequency at the UE 120 to drift from a target downlink frequency.

FIG. 5 illustrates an example 570 of an elevation angle 580. As shown, an elevation angle 580 may represent an angle between a ground surface (e.g., a horizontal axis, a surface datum, the Earth's surface, etc.) and a satellite 520 or 540 associated with the UE 120. A higher elevation angle 580 (e.g., a larger angle) may represent a satellite 520 or 540 that is closer to a vertical axis normal to the ground surface. A lower elevation angle 580 (e.g., a smaller angle) may represent a satellite 520 or 540 that is perceived by the UE 120 as closer to the ground surface. The elevation angle 580 may be correlated with path loss between the UE 120 and the satellite 520 or 540. For example, a higher elevation angle 580 may generally have a lower path loss than a lower elevation angle 580, since transmissions and receptions at the higher elevation angle 580 may propagate a shorter distance and may experience less atmospheric attenuation or distortion than transmissions at the lower elevation angle 580. Some techniques described herein provide selection of a number of repetitions (sometimes referred to as a repetition value) based at least in part on the elevation angle 580, which provides efficient selection of the number of repetitions to address path loss at different elevation angles 580. While the techniques described herein are described with regard to the elevation angle 580, these techniques can also be applied for an angle between the vertical axis and the communication path to the satellite 520 or 540 (that is, “90 degrees minus elevation angle 580”).

As indicated above, FIG. 5 is provided as an example. Other examples may differ from what is described with regard to FIG. 5.

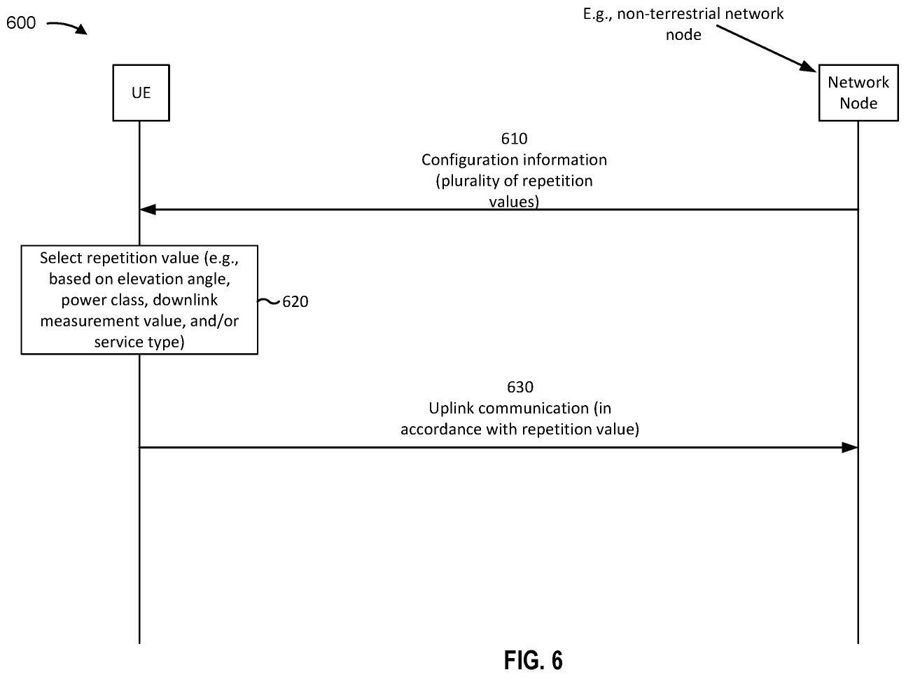

FIG. 6 is a diagram illustrating an example 600 of signaling associated with selecting a number of repetitions for an uplink transmission. As shown, example 600 includes a UE (e.g., UE 120) and a network node (e.g., BS 110, CU 210, DU 230, RU 240, satellite 520, satellite 540, gateway 550). In some aspects, the network node may be associated with an NTN. For example, the network node may be a network node of an NTN, referred to as a non-terrestrial network node. In some aspects, the UE may be another type of wireless communications device other than UE 120.

As shown by reference number 610, the UE may receive, and the network node may output (e.g., transmit or provide for transmission), configuration information. In some aspects, the configuration information may be provided via system information signaling, such as a system information block (SIB). In some aspects, the configuration information may include radio resource control (RRC) information, such as an RRC configuration or an RRC reconfiguration. In some aspects, the configuration information may include medium access control (MAC) information such as a MAC control element (MAC-CE). In some aspects, the configuration information may include dynamic signaling such as downlink control information.

The configuration information may indicate a plurality of repetition values. For example, the configuration information may include a field explicitly indicating one or more repetition values. As another example, the configuration information may indicate that a plurality of predefined repetition values (e.g., predefined in a wireless communication specification) is available for selection of a repetition value (e.g., the configuration information may point to the plurality of predefined repetition values). A repetition value identifies a number of repetitions of an uplink communication. In some aspects, the configuration information may indicate a range of repetition values (e.g., [8, 32], where 8 is a minimum number of repetitions and 32 is a maximum number of repetitions. In some aspects, the configuration information may indicate a step size for the range of repetition values (e.g., a step size of 8, in connection with a range of [8, 32], may mean that the UE can select 8, 16, 24, or 32 as a repetition value). In some aspects, the configuration information may explicitly identify the plurality of repetition values (e.g., [8 12 16 20 24 28 32], as one example). In some aspects, the configuration information may indicate an index into a table, where the table specifies multiple pluralities of repetition values. In some aspects, a parameter of the configuration information (e.g., which may be referred to as RepetitionList) may indicate the plurality of repetition values. In some aspects, the configuration information, or the plurality of repetition values, may be based at least in part on an uplink communication being directed to a non-terrestrial network node. For example, the configuration information or the plurality of repetition values may be specific to transmission to a network node of an NTN. In some aspects, the configuration information, or information indicating a criterion as described below, may be part of a PUSCH configuration (e.g., PUSCH-config).

In some aspects, the configuration information may include information indicating a criterion for selecting a repetition value from the plurality of repetition values. In some aspects, signaling separate from the configuration information may include the information indicating the criterion for selecting the repetition value. The criterion may indicate a mapping between one or more parameters and a corresponding repetition value. For example, the one or more parameters may include one or more of a power class of the UE, a downlink measurement value (e.g., reference signal received power (RSRP), among other examples), or an elevation angle (e.g., elevation angle 580). In some aspects, a parameter may be a range of elevation values (e.g., 30 degrees to 40 degrees). In some aspects, a parameter may be a range of downlink measurement values (e.g., −30 dBm to −40 dBm). In some aspects, a parameter may be a range of power classes (e.g., power class 2 and power class 3).

A power class is a parameter that defines parameters related to transmit power of a UE, such as a minimum peak effective isotropic radiated power or a maximum total radiated power, among other examples. Examples of power classes are defined in 3GPP Technical Specification 38.101-2. The downlink measurement value may indicate, for example, a result of an RSRP measurement or another type of measurement. The downlink measurement value may relate to a measurement on a reference signal, a downlink channel, or the like, transmitted by the network node. In some aspects, the UE may transmit information indicating the power class, the elevation angle, and/or the downlink measurement value to the network node (not shown). For example, the UE may report the downlink measurement value in accordance with a configuration, such as a reporting configuration pertaining to a reference signal or reference signal resource. In some aspects, the network node may determine the elevation angle. For example, the UE may report position information of the UE, and the network node may determine the elevation information using the position information.

As mentioned above, the criterion may be based at least in part on one or more parameters, including at least one of an elevation angle (for example, a smaller elevation angle indicating a satellite closer to the horizon may lead to selection of a larger number of repetitions), a downlink measurement value (e.g., a weaker downlink measurement value may lead to selection of a larger number of repetitions), a service type (e.g., a VoIP communication may lead to selection of, at most, a number of repetitions that does not exceed a length of time associated with a VoIP packet such as 20 ms), or a power class (e.g., a power class associated with a higher transmit power may lead to selection of a smaller repetition value). For example, the criterion may indicate a mapping between one or more parameters and a corresponding repetition value. In some aspects, the criterion may be specified by an information element (IE) (e.g., pusch-RepetitionCriterion). The IE may indicate a set of parameters and a corresponding repetition value. For example, the IE may specify a first set of parameters and a first corresponding repetition value, a second set of parameters and a second corresponding repetition value, and so on, for two or more repetition values. In one example, for parameters including power class and elevation angle, the IE may include “pusch-RepetitionCriterion::ENUMERATED {Elevation_PwClass1, Elevation_PwClass2, Elevation_PwClass3, Elevation_PwClass4}”, where each combination of elevation angle and power class is mapped to a repetition value. In another example, for parameters including power class and downlink RSRP, the IE may include “pusch-RepetitionCriterion::ENUMERATED {DLRSRP_PwClass1, DLRSRP_PwClass2, DLRSRP_PwClass3, DLRSRP_PwClass4}”, where each combination of downlink RSRP and power class is mapped to a repetition value.

In some aspects, the criterion may indicate a single parameter and a corresponding repetition value. For example, the criterion may indicate a mapping between repetition values and only one of downlink measurement values, power classes, or elevation angles. In some aspects, the criterion may indicate a selected criterion out of multiple criteria. For example, the criterion may indicate whether a first criterion (e.g., in which the repetition value is mapped to a power class and an elevation angle) or a second criterion (e.g., in which the repetition value is mapped to a power class and a downlink measurement value) is the selected criterion for selection of a repetition value.

In some aspects, the criterion may indicate a mapping between a set of parameters and a set of indexes. The configuration information may indicate a plurality of repetitions mapped to the set of indexes. The UE may select a repetition value by identifying an index mapped to a set of parameters (e.g., according to observed values of the set of parameters, such as a measured downlink measurement value, an observed elevation angle, or a power class of the UE) and by identifying a repetition value mapped to the index. In some aspects, the criterion (e.g., the mapping between the set of parameters and the set of indexes) may be specified in a table, such as a table of a wireless communication specification. Table 1, below, is an example of such a table pertaining to power class and elevation angle:

TABLE 1

| “pusch-RepetitionCriterion” is configured | | | “pusch- |
|---|---|---|---|
| UE power | Range of | Repetition | RepetitionCriterion” |
| class | elevation angle | value | is not configured |
| Class 2-26 | 30-40 | 16 | Use legacy approach |
| dBm | | | |
| Class 2-26 | 40-50 | 20 | |
| dBm | | | |
| | . . . | . . . | |

In some aspects, configuration information may omit the criterion. In some aspects, if the configuration information omits the criterion, the UE may use a legacy technique to select a number of repetitions, such as according to a number of repetitions indicated by a dynamic grant resource allocation table, a configured grant resource allocation table, or a higher layer configured parameter.

In some aspects, the set of parameters used to select the repetition value may include a service type of an uplink communication. For example, a service type may include a short message service (SMS) service type, a Voice over IP (VoIP) service type, an IoT service type, an ultra-reliable service type, or the like. Thus, the criterion may indicate one or more parameters of a power class, an elevation angle, a downlink measurement value, or a service type, and a mapping of the one or more parameters to a repetition value.

In some aspects, the configuration information (e.g., the criterion and/or the plurality of repetition values) may be signaled via a SIB, as mentioned above. Thus, the configuration information can be used to select a repetition value for transmission of a random access channel (RACH) message, such as RACH message 3. The network node may then transmit signaling (e.g., dedicated signaling) to overwrite the configuration information with an updated criterion or an updated plurality of repetition values. In some aspects, the network node may transmit signaling to deactivate the configuration information (e.g., such that the UE selects a repetition value using a legacy approach, as described above).

As shown by reference number 620, the UE may select a repetition value for a transmission of an uplink communication. Thus, the UE may identify a number of repetitions for transmission of the uplink communication. The UE may select the repetition value based at least in part on one or more parameters (e.g., elevation angle, power class, downlink measurement value, service type, or the like), as described below. For example, the UE may select a repetition value according to the configuration information. In this example, the UE may identify one or more parameters (e.g., an elevation angle, a downlink measurement value, a power class, a service type, or a combination thereof), and may identify an index or a repetition value mapped to the one or more parameters. In a situation where the repetition value is based on the elevation angle, the UE may identify the elevation angle as an elevation angle of the network node (e.g., a non-terrestrial network node associated with the uplink communication, such as a non-terrestrial network node to which the uplink communication is directed). In a situation where the repetition value is based on the downlink measurement value, the UE may identify a downlink measurement value associated with the network node (such as by measuring a downlink reference signal transmitted by the network node). The UE may select the repetition value in accordance with the mapping. In some aspects, the network node may identify the repetition value, such as according to an elevation angle (e.g., UE location information), a power class, and/or a downlink measurement value reported by the UE. For example, the network node may receive the reported value (e.g., an RSRP measured at the UE, UE location information, or the like) prior to a slot associated with the uplink communication. Thus, the network and the UE can have the same understanding of the elevation angle or the downlink measurement value to be used for deriving the repetition value.

As shown by reference number 630, the UE may transmit the uplink communication in accordance with the repetition value. For example, if the repetition value indicates X repetitions, the UE may transmit X repetitions of the uplink communication. The uplink communication may include, for example, a physical RACH (PRACH) transmission (e.g., PRACH message 1, message 3, message A, etc.), a physical uplink control channel (PUCCH) transmission (e.g., a transmission of uplink control information via a PUCCH), a PUSCH transmission, or the like. The network node may receive the uplink communication in accordance with the repetition value. For example, the network node may monitor for the number of repetitions of the uplink communication as defined by the repetition value.

In some aspects, the UE may transmit the uplink communication using the number of repetitions irrespective of whether a parameter (e.g., the elevation angle or the downlink measurement value) changes during transmission of the uplink communication. For example, after selecting the repetition value using an original elevation value (e.g., an elevation value implicitly or explicitly reported to a network node) or an original downlink measurement value (e.g., a downlink measurement value implicitly or explicitly reported to a network node), the UE may identify an updated elevation value or an updated downlink measurement value. The UE may transmit the uplink communication using the selected repetition value without selecting an updated repetition value using the updated value or the updated downlink measurement value. In some aspects, the UE may identify the updated elevation value or the updated downlink measurement value after reporting the original elevation value or the original downlink measurement value. In some aspects, the UE may identify the updated elevation value or the updated downlink measurement value during transmission of the number of repetitions. Thus, the UE may avoid a misalignment of repetition count between the UE and the network node.

As indicated above, FIG. 6 is provided as an example. Other examples may differ from what is described with regard to FIG. 6.

### Example Operations of a User Equipment

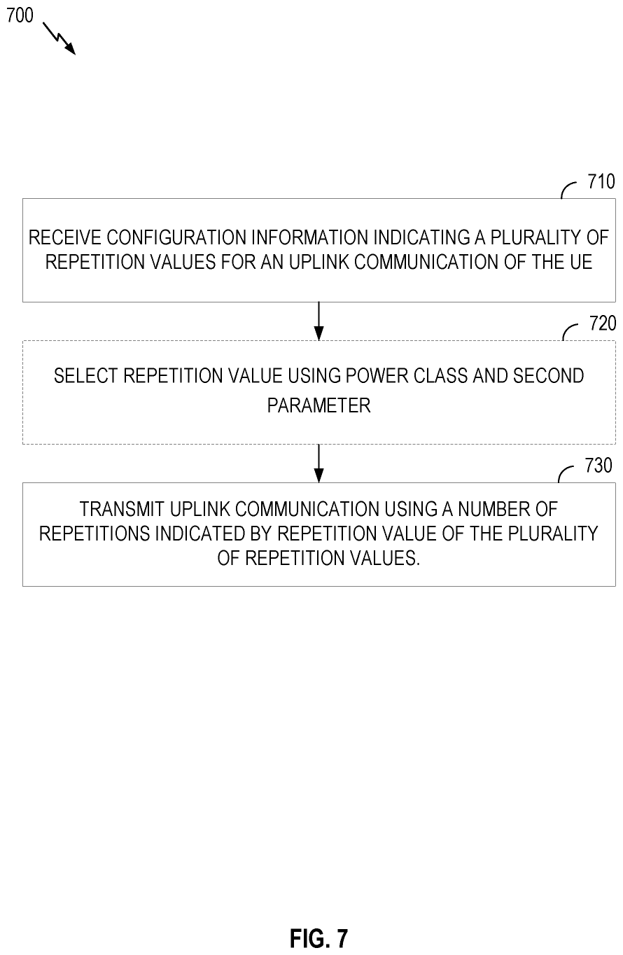

FIG. 7 shows a method 700 for wireless communications by a UE, such as UE 120 of FIGS. 1 and 3.

Method 700 begins at 710 with receiving configuration information indicating a plurality of repetition values for an uplink communication of the UE.

Method 700 then proceeds to step 720 with optionally selecting the repetition value using the power class and a second parameter.

Method 700 then proceeds to step 730 with transmitting the uplink communication using a number of repetitions indicated by a repetition value of the plurality of repetition values. In some aspects, the repetition value is based at least in part on a power class of the UE. In some aspects, the repetition value is not based on the power class of the UE, as described elsewhere herein.

In one aspect, the repetition value is based at least in part on an elevation angle of a non-terrestrial network node associated with the uplink communication.

In one aspect, at least one of the elevation angle or the power class is mapped to the repetition value.

In one aspect, transmitting the uplink communication using the number of repetitions further comprises transmitting the uplink communication using the number of repetitions irrespective of whether the elevation angle changes during transmission of the uplink communication.

In one aspect, the number of repetitions is in accordance with an original elevation angle, and the method 700 further comprises identifying a changed elevation angle during transmission of the uplink communication.

In one aspect, the repetition value is based at least in part on a downlink measurement value associated with a non-terrestrial network node associated with the uplink communication.

In one aspect, at least one of the downlink measurement value or the power class is mapped to the repetition value by a table.

In one aspect, transmitting the uplink communication using the number of repetitions further comprises transmitting the uplink communication using the number of repetitions irrespective of whether the downlink measurement value changes during transmission of the uplink communication.

In one aspect, the number of repetitions is in accordance with an original downlink measurement value, and the method 700 further includes identifying a changed downlink measurement value during transmission of the uplink communication.

In one aspect, the method 700 includes receiving information indicating a criterion for selecting the repetition value from the plurality of repetition values.

In one aspect, the criterion is based at least in part on at least one of the power class, a downlink measurement value associated with a non-terrestrial network node associated with the uplink communication, or an elevation angle of the non-terrestrial network node.

In one aspect, receiving the configuration information further comprises receiving the configuration information, or information indicating a criterion for selecting the repetition value, via system information signaling.

In one aspect, the uplink communication comprises at least one of a physical random access channel transmission, a physical uplink control channel transmission, or a physical uplink shared channel transmission.

In one aspect, the repetition value is based at least in part on a service type of the uplink communication.

In one aspect, at least one of the configuration information or the repetition value is based at least in part on the uplink communication being directed to a non-terrestrial network node.

In one aspect, method 700 includes selecting the repetition value using the power class and a second parameter.

In one aspect, the second parameter includes at least one of an elevation angle, a service type, or a downlink measurement value.

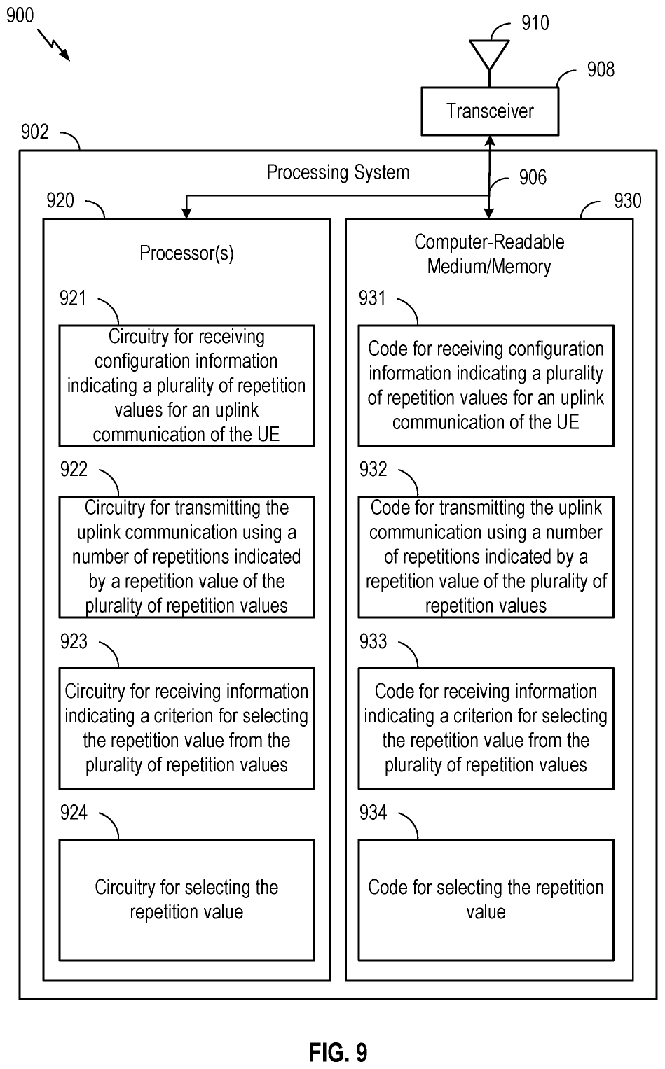

Method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative steps are consistent with this disclosure.

### Example Operations of a Network Entity

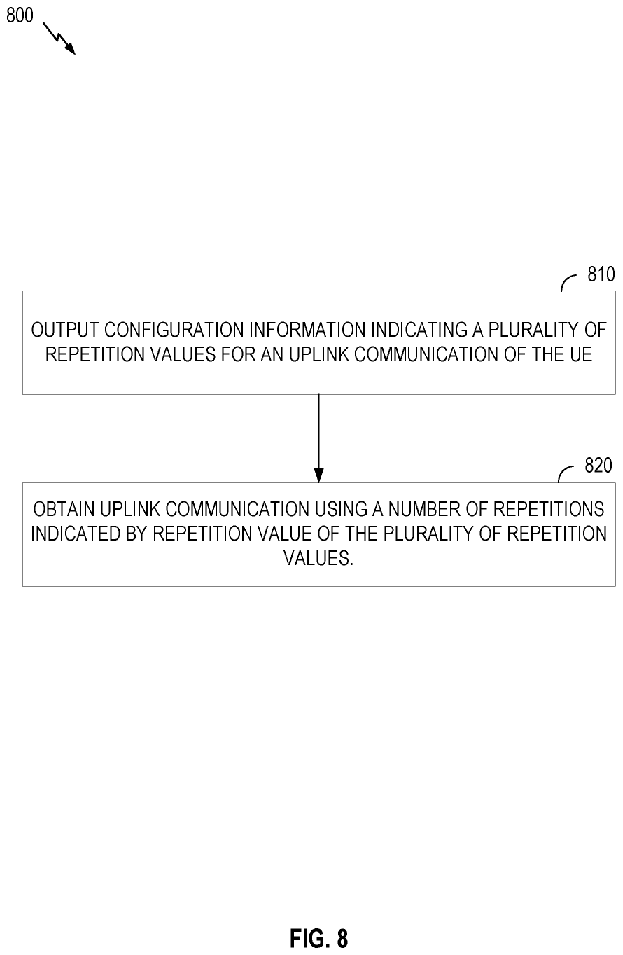

FIG. 8 shows a method 800 for wireless communications by a network node, such as BS 110 of FIGS. 1 and 3, or a disaggregated base station as discussed with respect to FIG. 2.

Method 800 begins at 810 with outputting configuration information indicating a plurality of repetition values for an uplink communication of a UE. For example, the network node may transmit the configuration information, or may provide the configuration information for transmission by another network node.

Method 800 then proceeds to step 820 with obtaining the uplink communication using a number of repetitions indicated by a repetition value of the plurality of repetition values, wherein the repetition value is based at least in part on a power class of the UE. For example, the network node may monitor for the uplink communication in accordance with the number of repetitions, or may cause another network node to monitor for the uplink communication in accordance with the number of repetitions.

In one aspect, the repetition value is based at least in part on an elevation angle of the UE.

In one aspect, at least one of the elevation angle or the power class is mapped to the repetition value by a table.

In one aspect, the repetition value is based at least in part on a downlink measurement value.

In one aspect, at least one of the downlink measurement value or the power class is mapped to the repetition value by a table.

In one aspect, method 800 includes outputting information indicating a criterion for selecting the repetition value from the plurality of repetition values.

In one aspect, the criterion is a function of at least one of the power class, a downlink measurement value, or an elevation angle.

In one aspect, outputting the configuration information further comprises outputting the configuration information or information indicating a criterion for selecting the repetition value via system information signaling.

In one aspect, the uplink communication comprises at least one of a physical random access channel transmission, a physical uplink control channel transmission, or a physical uplink shared channel transmission.

In one aspect, the repetition value is based at least in part on a service type associated with the uplink communication.

In one aspect, at least one of the configuration information or the repetition value is based at least in part on the uplink communication being directed to a non-terrestrial network node.

In one aspect, the network node is the non-terrestrial network node.

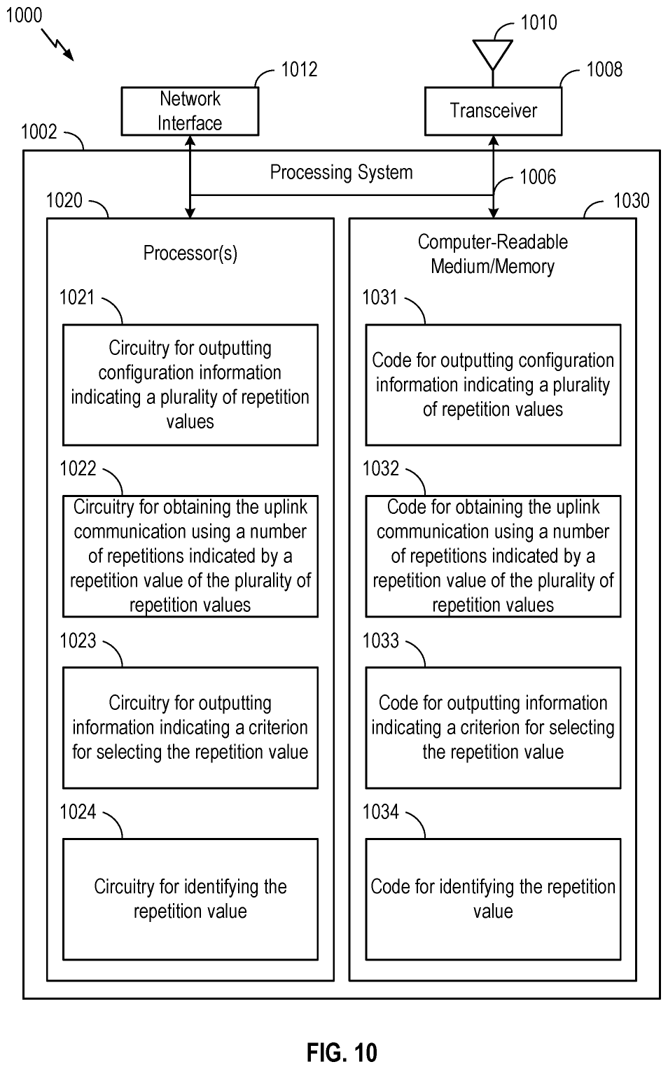

Method 800, or any aspect related to it, may be performed by an apparatus, such as communications device 1000 of FIG. 10, which includes various components operable, configured, or adapted to perform the method 800. Communications device 1000 is described below in further detail.

In one aspect, method 800 includes identifying the repetition value.

Note that FIG. 8 is just one example of a method, and other methods including fewer, additional, or alternative steps are consistent with this disclosure.

### Example Communications Devices

FIG. 9 depicts aspects of an example communications device 900. In some aspects, communications device 900 is a user equipment, such as UE 120 described above with respect to FIGS. 1 and 3.

The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes one or more processors 920. In various aspects, the one or more processors 920 may be representative of one or more of receive processor 358, transmit processor 364, TX MIMO processor 366, and/or controller/processor 380, as described with respect to FIG. 3. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the method 700 described with respect to FIG. 7, or any aspect related to it. Note that reference to a processor performing a function of communications device 900 may include one or more processors performing that function of communications device 900.

In the depicted example, computer-readable medium/memory 930 stores code (e.g., executable instructions) 931 for receiving configuration information indicating a plurality of repetition values for an uplink communication of the UE, code 932 for transmitting the uplink communication using a number of repetitions indicated by a repetition value of the plurality of repetition values, code 933 for receiving information indicating a criterion for selecting the repetition value from the plurality of repetition values, and code 934 for selecting the repetition value. Processing of the code 931-934 may cause the communications device 900 to perform the method 700 described with respect to FIG. 7, or any aspect related to it.

The one or more processors 920 include circuitry configured to implement (e.g., execute) the code stored in the computer-readable medium/memory 930, including circuitry 921 for receiving configuration information indicating a plurality of repetition values for an uplink communication of the UE, circuitry 922 for transmitting the uplink communication using a number of repetitions indicated by a repetition value of the plurality of repetition values, circuitry 923 for receiving information indicating a criterion for selecting the repetition value from the plurality of repetition values, and circuitry 924 for selecting the repetition value. Processing with circuitry 921-924 may cause the communications device 900 to perform the method 700 described with respect to FIG. 7, or any aspect related to it.

Various components of the communications device 900 may provide means for performing the method 700 described with respect to FIG. 7, or any aspect related to it. For example, means for transmitting, sending, or outputting for transmission may include the transceivers 354 and/or antenna(s) 352 of the UE 120 illustrated in FIG. 3 and/or transceiver 908 and antenna 910 of the communications device 900 in FIG. 9. Means for receiving or obtaining may include the transceivers 354 and/or antenna(s) 352 of the UE 120 illustrated in FIG. 3 and/or transceiver 908 and antenna 910 of the communications device 900 in FIG. 9.

FIG. 10 depicts aspects of an example communications device. In some aspects, communications device 1000 is a network entity, such as BS 110 of FIGS. 1 and 3, or a disaggregated base station as discussed with respect to FIG. 2.

The communications device 1000 includes a processing system 1002 coupled to a transceiver 1008 (e.g., a transmitter and/or a receiver) and/or a network interface 1012. The transceiver 1008 is configured to transmit and receive signals for the communications device 1000 via an antenna 1010, such as the various signals as described herein. The network interface 1012 is configured to obtain and send signals for the communications device 1000 via communications link(s), such as a backhaul link, midhaul link, and/or fronthaul link as described herein, such as with respect to FIG. 2. The processing system 1002 may be configured to perform processing functions for the communications device 1000, including processing signals received and/or to be transmitted by the communications device 1000.

The processing system 1002 includes one or more processors 1020. In various aspects, one or more processors 1020 may be representative of one or more of receive processor 338, transmit processor 320, TX MIMO processor 330, and/or controller/processor 340, as described with respect to FIG. 3. The one or more processors 1020 are coupled to a computer-readable medium/memory 1030 via a bus 1006. In certain aspects, the computer-readable medium/memory 1030 is configured to store instructions (e.g., computer-executable code) that when executed by the one or more processors 1020, cause the one or more processors 1020 to perform the method 800 described with respect to FIG. 8, or any aspect related to it. Note that reference to a processor of communications device 1000 performing a function may include one or more processors of communications device 1000 performing that function.

In the depicted example, the computer-readable medium/memory 1030 stores code 1031 (e.g., executable instructions) for outputting configuration information indicating a plurality of repetition values, code 1032 for obtaining the uplink communication using a number of repetitions indicated by a repetition value of the plurality of repetition values, code 1033 for outputting information indicating a criterion for selecting the repetition value, and code 1034 for identifying the repetition value. Processing of the code 1031-1034 may cause the communications device 1000 to perform the method 800 described with respect to FIG. 8, or any aspect related to it.

The one or more processors 1020 include circuitry configured to implement (e.g., execute) the code stored in the computer-readable medium/memory 1030, including circuitry 1021 for outputting configuration information indicating a plurality of repetition values, circuitry 1022 for obtaining the uplink communication using a number of repetitions indicated by a repetition value of the plurality of repetition values, circuitry 1023 for outputting information indicating a criterion for selecting the repetition value, and circuitry 1024 for identifying the repetition value. Processing with circuitry 1021-1024 may cause the communications device 1000 to perform the method 800 as described with respect to FIG. 8, or any aspect related to it.

Various components of the communications device 1000 may provide means for performing the method 800 as described with respect to FIG. 8, or any aspect related to it. Means for transmitting, sending, or outputting for transmission may include the transceivers 332 and/or antenna(s) 334 of the BS 110 illustrated in FIG. 3 and/or transceiver 1008 and antenna 1010 of the communications device 1000 in FIG. 10. Means for receiving or obtaining may include the transceivers 332 and/or antenna(s) 334 of the BS 110 illustrated in FIG. 3 and/or transceiver 1008 and antenna 1010 of the communications device 1000 in FIG. 10.

### Example Clauses

Implementation examples are described in the following numbered clauses:

Clause 1: A method of wireless communication performed by an apparatus of a user equipment (UE), comprising receiving configuration information indicating a plurality of repetition values for an uplink communication of the UE; and transmitting the uplink communication using a number of repetitions indicated by a repetition value of the plurality of repetition values, wherein the repetition value is based at least in part on a power class of the UE.

Clause 2: The method of Clause 1, wherein the repetition value is based at least in part on an elevation angle of a non-terrestrial network node associated with the uplink communication.

Clause 3: The method of Clause 2, wherein at least one of the elevation angle or the power class is mapped to the repetition value.

Clause 4: The method of Clause 2, wherein transmitting the uplink communication using the number of repetitions further comprises transmitting the uplink communication using the number of repetitions irrespective of whether the elevation angle changes during transmission of the uplink communication.

Clause 5: The method of Clause 4, wherein the number of repetitions is in accordance with an original elevation angle, and wherein the method further comprises identifying a changed elevation angle during transmission of the uplink communication.

Clause 6: The method of any of Clauses 1-5, further comprising reporting at least one of an elevation angle or a downlink measurement value of the UE to a network node.

Clause 7: The method of any of Clauses 1-6, wherein the repetition value is based at least in part on a downlink measurement value associated with a non-terrestrial network node associated with the uplink communication.

Clause 8: The method of Clause 7, wherein at least one of the downlink measurement value or the power class is mapped to the repetition value.

Clause 9: The method of Clause 7, wherein transmitting the uplink communication using the number of repetitions further comprises transmitting the uplink communication using the number of repetitions irrespective of whether the downlink measurement value changes during transmission of the uplink communication.

Clause 10: The method of Clause 9, wherein the number of repetitions is in accordance with an original downlink measurement value, and wherein the method further comprises identifying a changed downlink measurement value during transmission of the uplink communication.

Clause 11: The method of any of Clauses 1-10, further comprising receiving information indicating a criterion for selecting the repetition value from the plurality of repetition values.

Clause 12: The method of Clause 11, wherein the criterion is based at least in part on at least one of the power class, a downlink measurement value associated with a non-terrestrial network node associated with the uplink communication, or an elevation angle of the non-terrestrial network node.

Clause 13: The method of Clause 12, further comprising selecting the repetition value in accordance with the criterion.

Clause 14: The method of any of Clauses 1-13, wherein receiving the configuration information further comprises receiving the configuration information, or information indicating a criterion for selecting the repetition value, via system information signaling.

Clause 15: The method of any of Clauses 1-14, wherein the uplink communication comprises at least one of: a physical random access channel transmission, a physical uplink control channel transmission, or a physical uplink shared channel transmission.

Clause 16: The method of any of Clauses 1-15, wherein the repetition value is based at least in part on a service type of the uplink communication.

Clause 17: The method of any of Clauses 1-16, wherein at least one of the configuration information or the repetition value is based at least in part on the uplink communication being directed to a non-terrestrial network node.

Clause 18: The method of any of Clauses 1-17, further comprising selecting the repetition value using the power class and a second parameter.

Clause 19: The method of Clause 18, wherein the second parameter includes at least one of an elevation angle, a service type, or a downlink measurement value.

Clause 20: A method of wireless communication performed by a network node, comprising: outputting configuration information indicating a plurality of repetition values for an uplink communication of a user equipment (UE); and obtaining the uplink communication using a number of repetitions indicated by a repetition value of the plurality of repetition values, wherein the repetition value is based at least in part on a power class of the UE.

Clause 21: The method of Clause 20, wherein the repetition value is based at least in part on an elevation angle of the UE.

Clause 22: The method of Clause 21, wherein at least one of the elevation angle or the power class is mapped to the repetition value.

Clause 23: The method of any of Clauses 20-22, wherein the repetition value is based at least in part on a downlink measurement value.

Clause 24: The method of any of Clauses 20-23, further comprising outputting information indicating a criterion for selecting the repetition value from the plurality of repetition values.

Clause 25: The method of any of Clauses 20-24, wherein outputting the configuration information further comprises outputting the configuration information or information indicating a criterion for selecting the repetition value via system information signaling.

Clause 26: The method of any of Clauses 20-25, wherein the uplink communication comprises at least one of: a physical random access channel transmission, a physical uplink control channel transmission, or a physical uplink shared channel transmission.

Clause 27: The method of any of Clauses 20-26, wherein the repetition value is based at least in part on a service type associated with the uplink communication.

Clause 28: The method of any of Clauses 20-27, wherein at least one of the configuration information or the repetition value is based at least in part on the uplink communication being directed to a non-terrestrial network node.

Clause 29: An apparatus, comprising: a memory comprising executable instructions; and a processor configured to execute the executable instructions and cause the apparatus to perform a method in accordance with any one of Clauses 1-28.

Clause 30: An apparatus, comprising means for performing a method in accordance with any one of Clauses 1-28.

Clause 31: A non-transitory computer-readable medium comprising executable instructions that, when executed by a processor of an apparatus, cause the apparatus to perform a method in accordance with any one of Clauses 1-28.

Clause 32: A computer program product embodied on a computer-readable storage medium comprising code for performing a method in accordance with any one of Clauses 1-28.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication performed by an apparatus of a user equipment (UE), comprising:
receiving configuration information indicating a plurality of repetition values for an uplink communication of the UE; and
transmitting the uplink communication using a number of repetitions indicated by a repetition value of the plurality of repetition values, wherein the repetition value is based at least in part on a power class of the UE.

2. The method of claim 1, wherein the repetition value is based at least in part on an elevation angle of a non-terrestrial network node associated with the uplink communication.

3. The method of claim 2, wherein at least one of the elevation angle or the power class is mapped to the repetition value.

4. The method of claim 2, wherein transmitting the uplink communication using the number of repetitions further comprises transmitting the uplink communication using the number of repetitions irrespective of whether the elevation angle changes during transmission of the uplink communication.

5. The method of claim 4, wherein the number of repetitions is in accordance with an original elevation angle, and wherein the method further comprises identifying a changed elevation angle during transmission of the uplink communication.

6. The method of claim 1, further comprising reporting at least one of an elevation angle or a downlink measurement value of the UE to a network node.

7. The method of claim 1, wherein the repetition value is based at least in part on a downlink measurement value associated with a non-terrestrial network node associated with the uplink communication.

8. The method of claim 7, wherein at least one of the downlink measurement value or the power class is mapped to the repetition value.

9. The method of claim 7, wherein transmitting the uplink communication using the number of repetitions further comprises transmitting the uplink communication using the number of repetitions irrespective of whether the downlink measurement value changes during transmission of the uplink communication.

10. The method of claim 9, wherein the number of repetitions is in accordance with an original downlink measurement value, and wherein the method further comprises identifying a changed downlink measurement value during transmission of the uplink communication.

11. The method of claim 1, further comprising receiving information indicating a criterion for selecting the repetition value from the plurality of repetition values.

12. The method of claim 11, wherein the criterion is based at least in part on at least one of the power class, a downlink measurement value associated with a non-terrestrial network node associated with the uplink communication, or an elevation angle of the non-terrestrial network node.

13. The method of claim 12, further comprising selecting the repetition value in accordance with the criterion.

14. The method of claim 1, wherein receiving the configuration information further comprises receiving the configuration information, or information indicating a criterion for selecting the repetition value, via system information signaling.

15. The method of claim 1, wherein the uplink communication comprises at least one of:
a physical random access channel transmission,
a physical uplink control channel transmission, or
a physical uplink shared channel transmission.

16. The method of claim 1, wherein the repetition value is based at least in part on a service type of the uplink communication.

17. The method of claim 1, wherein at least one of the configuration information or the repetition value is based at least in part on the uplink communication being directed to a non-terrestrial network node.

18. The method of claim 1, further comprising selecting the repetition value using the power class and a second parameter.

19. The method of claim 18, wherein the second parameter includes at least one of an elevation angle, a service type, or a downlink measurement value.

20. A method of wireless communication performed by a network node, comprising:
outputting configuration information indicating a plurality of repetition values for an uplink communication of a user equipment (UE); and
obtaining the uplink communication using a number of repetitions indicated by a repetition value of the plurality of repetition values, wherein the repetition value is based at least in part on a power class of the UE.

21. The method of claim 20, wherein the repetition value is based at least in part on an elevation angle of the UE.

22. The method of claim 21, wherein at least one of the elevation angle or the power class is mapped to the repetition value.

23. The method of claim 20, wherein the repetition value is based at least in part on a downlink measurement value.

24. The method of claim 20, further comprising outputting information indicating a criterion for selecting the repetition value from the plurality of repetition values.

25. The method of claim 20, wherein outputting the configuration information further comprises outputting the configuration information or information indicating a criterion for selecting the repetition value via system information signaling.

26. The method of claim 20, wherein the uplink communication comprises at least one of:
a physical random access channel transmission,
a physical uplink control channel transmission, or
a physical uplink shared channel transmission.

27. The method of claim 20, wherein the repetition value is based at least in part on a service type associated with the uplink communication.

28. The method of claim 20, wherein at least one of the configuration information or the repetition value is based at least in part on the uplink communication being directed to a non-terrestrial network node.

29. A user equipment (UE) for wireless communication, comprising:
a memory; and
one or more processors, coupled to the memory, configured to:
receive configuration information indicating a plurality of repetition values for an uplink communication of the UE; and
transmit the uplink communication using a number of repetitions indicated by a repetition value of the plurality of repetition values, wherein the repetition value is based at least in part on a power class of the UE.

30. A network node for wireless communication, comprising:
a memory; and
one or more processors, coupled to the memory, configured to:
output configuration information indicating a plurality of repetition values for an uplink communication of a user equipment (UE); and
obtain the uplink communication using a number of repetitions indicated by a repetition value of the plurality of repetition values, wherein the repetition value is based at least in part on a power class of the UE.
